(19) United States
(12) Patent Application Publication
(10) Pub. No.: US 2024/0082918 A1
(43) Pub. Date: Mar. 14, 2024

(54) CONTROLLING COPPER-CONTAINING GREEN BODY OBJECT DEFORMATION

(71) Applicant: Hewlett-Packard Development Company, L.P., Spring, TX (US)

(72) Inventors: John Samuel Dilip JANGAM, Palo Alto, CA (US); Thomas Craig ANTHONY, Palo Alto, CA (US); Lihua ZHAO, Palo Alto, CA (US)

(21) Appl. No.: 18/271,657

(22) PCT Filed: Jan. 15, 2021
(86) PCT No.: PCT/US2021/013686

§ 371 Date: Jul. 10, 2023

(51) Int. Cl. B22F 10/25; B22F 10/30; B22F 10/62

(52) U.S. Cl. CPC B22F 10/25; B22F 10/30; B22F 10/62; B33Y 10/00

(57) ABSTRACT

A three-dimensional printing kit can include a particulate build material with from about 80 wt % to 100 wt % copper-containing build particles having a D50 particle size distribution value from about 1 μm to about 150 μm, a binding agent including a build binder to apply to particulate build material layers to form a green body object, and a shaping composition to apply to a surface of the green body object and to control green body object deformation. The shaping composition can include from about 10 wt % to about 80 wt % liquid vehicle and from about 20 wt % to about 90 wt % metal shaping particles having a D50 particle size distribution value from about 100 nm to about 100 μm. The metal shaping particles can be smaller than the copper-containing build particles.

### BACKGROUND

Three-dimensional (3D) printing may be an additive printing process used to make three-dimensional solid parts from a digital model. Three-dimensional printing is often used in rapid product prototyping, mold generation, mold master generation, and short run manufacturing. Some three-dimensional printing techniques are considered additive processes because they involve the application of successive layers of material. This is unlike other machining processes, which often rely upon the removal of material to create the final part. Some three-dimensional printing methods use chemical binders or adhesives to bind build materials together. Other three-dimensional printing methods involve partial sintering, melting, etc. of the build material. For some materials, partial melting may be accomplished using heat-assisted extrusion, and for some other materials curing or fusing may be accomplished using, for example, ultra-violet light or infrared light.

### BRIEF DESCRIPTION OF THE DRAWINGS

FIG. 1 illustrates an example three-dimensional printing kit in accordance with the present disclosure;

FIG. 2 illustrates an example of the three-dimensional printing kit of FIG. 1 associated with an additive manufacturing three-dimensional printer in accordance with the present disclosure;

FIG. 3 is a flow diagram of an example method of controlling green body object deformation in accordance with the present disclosure; and

FIG. 4 illustrates comparative green body objects prepared with and without the example shaping compositions of the present disclosure.

### DETAILED DESCRIPTION

Three-dimensional (3D) printing can be an additive process that can involve the application of successive layers of copper-containing build material with build binders or adhesives printed thereon to bind the successive layers of the copper-containing build materials together. In some processes, application of build binder can be utilized to form a green body object and then a fused three-dimensional physical object can be formed therefrom. More specifically, binding agent can be selectively applied to a layer of a copper-containing build material on a support bed to pattern a selected region of the layer and then another layer of the copper-containing build material is applied thereon. The binding agent can be applied to another layer of the copper-containing build material and these processes can be repeated to form a green part or object. The green body object can be sintered or otherwise heat-fused to form a fused metal object. However, during the heat-fusing process, with many green body objects prepared or printed with copper-containing build particles and a build binder, the build binder may not be fully available while ramping the temperature of the fusing oven up to sintering or other heat-fusing temperatures for the copper-containing build particles, as the build binder may burn off or otherwise may not be effective at binding at temperatures before copper-containing build material begins to become fused in earnest.

A “fusing oven” is understood to be an oven where the temperature can be ramped up through intermediate temperatures to heat-fusing temperatures of the copper-containing build particles. Copper-containing build particles can be elemental copper metal particles (e.g., about 99 wt % to 100 wt % copper), for example, and can start to become heat-fused at temperatures ranging from about 500° C. to about 900° C. in an intermediate temperature range (where the shaping composition can be particularly helpful in supporting the three-dimensional object), and more sintering in earnest may take place at heat-fusing fusing temperature ranging from about 900° C. to about 1080° C., or from about 950° C. to about 1065° C., depending in part on the particle size distribution of the copper metal particles and the time soaking within this heat-fusing temperature range. Notably, copper alloy particles with a high weight ratio of elemental copper (e.g., from about 50 wt % to about 99 wt % copper) can become heat-fused at from about 450° C. to about 1075° C., for example, depending on the other elements present in the alloy, the particle size distribution of the copper alloy particles, and the time soaking within this heat-fusing temperature range. Thus, intermediate temperatures for copper alloy particles may range from about 450° C. to about 900° C., with heat-fusing temperatures ranging from about 850° C. to about 1075° C. Thus, some binders used to hold the green body object together are not effective at controlling sagging of cantilevered or spanned regions of the green body object as they pass through intermediate temperatures approaching these heat-fusing temperatures. For example, in considering elemental copper (>about 99 wt % copper), as the heat fusing oven exceeds about 500° C., copper particle-to-particle necking (metallurgical inter-particle bridges) can be observed and may begin to increase. This can start to impart some added strength to the sintering part. In one example, the intermediate temperature can range from about 450° C. to about 900° C., from about 500° C. to about 900° C., or from about 450° C. to about 850° C., and the fusing temperature range from about 850° C. to about 1080° C., from about 900° C. to about 1080° C., from about 850° C. to about 1075° C., from about 900° C. to about 1075° C., or more typically, from about about 950° C. to about 1065° C.

Regarding the intermediate temperatures (where some minimal fusing can occur, but also a significant amount of sagging may occur), it has been observed that at temperatures above about 650° C., the green body object may exhibit some necking, which in many instances can provide enough strength to start to become self-supportive, depending on the length of a given spanned region or cantilevered structure that may be present. In further detail, the intermediate temperature where necking begins to occur can depend on what type of copper-containing build particles are used, e.g., about 99 wt % to about 100 wt % elemental copper or about 50 wt % to about 99 wt % copper in a copper alloy, the particle size, the atmosphere of the fusing oven, etc. Without being limiting and depending on the alloyed copper-containing build particles used and other factors, necking may begin within the range of about 600° C. to about 700° C. Either way, until this necking of particle-to-particle strength begins or becomes established, there is an intermediate temperature range where the green body object is subject to sagging. In accordance with examples of the present disclosure, shaping compositions can be applied to green body objects at certain locations with certain coating thicknesses to provide for sag resistance through intermediate temperatures during temperature ramp up to heat-fusing temperatures.

In accordance with this and examples of the present disclosure, a three-dimensional printing kit can include a particulate build material comprising about 80 wt % to 100 wt % copper-containing build particles having a D50 particle size distribution value from about 1 μm to about 150 μm, and a binding agent including a build binder to apply to particulate build material layers to form a green body object. The three-dimensional printing kit could also include a shaping composition to apply to a surface of the green body object and to control green body object deformation. The shaping composition can include from about 10 wt % to about 80 wt % liquid vehicle and from about 20 wt % to about 90 wt % metal shaping particles having a D50 particle size distribution value from about 100 nm to about 100 μm. In this example, the metal shaping particles can also be smaller than the copper-containing build particles. In one example, the metal shaping particles can be iron particles having a D50 particle size from about 1 μm to about 75 μm. In another example, the metal shaping particles can be nickel particles having a D50 particle size from about 100 nm to about 20 μm. In another example, the metal shaping particles can be high melting point alloyed metal particles selected from stainless steel particles, Ti—Al—V, or a combination thereof, with the high melting point alloyed particles having a D50 particle size from about 1 μm to 50 μm. The metal shaping particles can alternatively be low melting point particles selected from copper particles, aluminum particles, Al—Si particles, or Al—Si—Mg particles, with the low melting point particles having a D50 particle size from about 100 nm to about 20 μm. In other examples, the copper-containing build particles can include copper alloy particles comprising from about 50 wt % to about 99 wt % elemental copper, or the copper-containing build particles can include elemental copper particles having a purity from about 99 wt % to 100 wt %. In another example, the shaping composition can be a slurry having a viscosity from about 50 cps to about 5000 cps.

In another example, a method of controlling green body object deformation can include applying a coating of shaping composition to a surface of a green body object at a surface location to counteract temperature induced deformation of the green body object. The green body object can include copper-containing build particles bound together with build binder. The shaping composition can include metal shaping particles having a D50 particle size distribution value from about 100 nm to about 100 μm. The metal shaping particles can be smaller in average size than the copper-containing build particles. In further detail, the method can include ramping-up the temperature applied to the green body object to an intermediate temperature range where the metal shaping particles interact with copper-containing build particles of the green body object. The shaping composition counteracts temperature induced deformation of the green body object while the green body object is within the intermediate temperature range. The method can further include fusing the green body object at a heat-fusing temperature above the intermediate temperature range to form a fused metal object that includes a copper-containing metal body formed from the copper-containing build-particles having a metal coating formed from the metal shaping particles. In one specific example, the method can include forming the green body object by iteratively applying individual build material layers of a particulate build material including the copper-containing build particles, and based on a 3D object model, selectively applying a binding agent to individual build material layers to define individually patterned layers that are built up and bound together to form the green body object. In another example, the method can include removing residual metal shaping particles after fusing leaving the metal coating applied on the copper-containing metal body at an average thickness where applied at from about 100 μm to about 2 mm with an alloyed interface from about 1 μm to about 200 μm in thickness.

In another example, a three-dimensional printed metal object can include a copper-containing metal body of heat-fused copper-containing metal particles having a volume density from about 80% to about 99%, and a metal coating on the copper-containing metal body. The metal coating can have an average thickness where present at from about 100 μm to about 2 mm and an alloyed interface from about 1 μm to about 200 μm in thickness. The metal coating can have a density difference from about 5% to about 40% by volume relative to the copper-containing metal body. In one example, the metal coating can be from about 5% to about 25% denser by volume relative to the copper-containing metal body, and the metal coating can include copper, Al—Si—Mg, or a combination thereof. In another example, the metal coating can be from about 5% to about 25% less dense by volume relative to the copper-containing metal body, and the metal coating can include aluminum, iron, stainless steel, nickel, Ti—Al—V, or a combination thereof.

It is noted that when discussing the three-dimensional printing kits, methods of controlling green body deformation, and/or three-dimensional printed objects herein, these discussions can be considered applicable to one another whether or not they are explicitly discussed in the context of that example. Thus, for example, when discussing the shaping composition in the context of three-dimensional printing kits, such disclosure is also relevant to and directly supported in the context of the methods and/or objects, and vice versa, regardless of any scope of description differences.

It is also understood that terms used herein will take on their ordinary meaning in the relevant technical field unless specified otherwise. In some instances, there are terms defined more specifically throughout the specification or included at the end of the present specification, and thus, these terms can have a meaning as described herein.

### Three-Dimensional Printing Kits

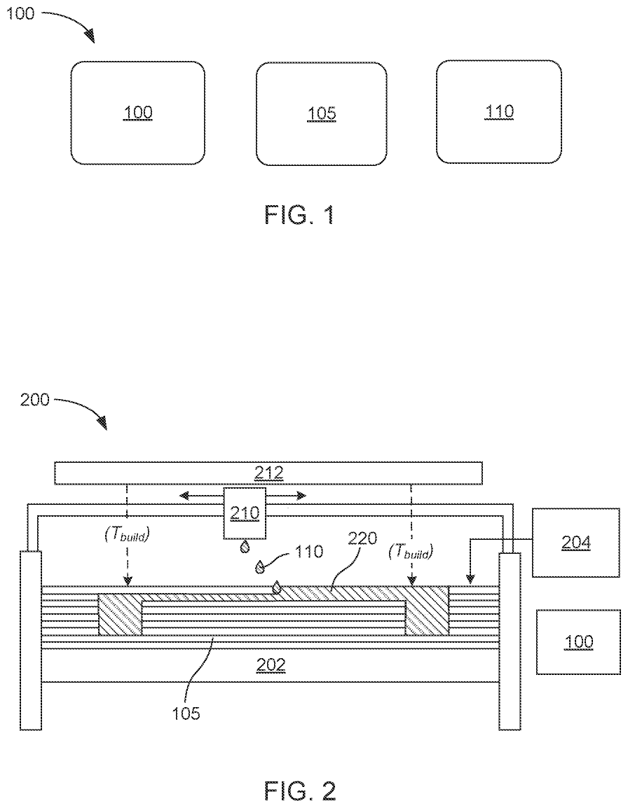

In accordance with examples of the present disclosure, a three-dimensional printing kit 100 is shown in FIG. 1. The three-dimensional printing kit can include a copper-containing build material 105 including about 80 wt % to 100 wt % copper-containing build particles having a D50 particle size distribution value from about 1 μm to about 150 μm, a binding agent 110 to apply to the copper-containing build material layers to form a green body object, and a shaping composition 100. The shaping composition can include any of a number of types of metal shaping particles to apply to a surface of the green body object to introduce a shaping composition-induced surface support to the copper-containing green body object, as metal particles of different types and/or sizes interact upon application of heat. For example metal shaping particles of the shaping composition and the copper-containing metal particles of the green body object can diffuse into one another at the surface where the shaping composition is applied to the green body object, leaving an alloyed interface where the shaping composition is applied. The shaping composition can also ameliorate deformation or promote affirmative deformation during ramp up intermediate temperatures prior to sintering of the green body object, for example. Thus, the binding agent can be applied iteratively on a layer-by-layer basis to the copper-containing build material to form the green body object, and the shaping composition can be applied to the green body object to provide support to the green body object during the heat-fusing process.

To illustrate an example additive manufacturing process that can be implemented in accordance with the present disclosure, FIG. 2 illustrates an example three-dimensional printing system that can be used. For example, the three-dimensional printing kit of FIG. 1 is shown in use with the copper-containing build material 105 and the binding agent 110 loaded in a three-dimensional printing apparatus 200. In this example, the shaping composition 100 is shown next to the three-dimensional printing apparatus in preparation for applying to a green body object 220 once formed and removed from on top of the build platform 202 and from within residual copper-containing build material that is not used to form the green body object. In this example, the copper-containing build material can be deposited from a build material applicator 204 onto the build platform where it can be flattened or smoothed on a layer by layer basis, such as by a mechanical roller or other flattening technique. A layer of the copper-containing build material, which typically includes from mostly to all copper-containing build particles, e.g., from about 80 wt % to 100 wt %, can be deposited and spread out evenly at the top surface. The layer of copper-containing build material can be applied to the powder bed at from about 25 μm to about 400 μm, from about 75 μm to about 400 μm, from about 100 μm to about 400 μm, from about 150 μm to about 350 μm, or from about 200 μm to about 350 μm, for example. The binding agent can be used to generate the green body object on a layer-by-layer basis, for example. Individual layers of copper-containing build material and previously formed green body object layers are shown, but are not to scale. In this example, the binding agent may include water and a build binder, such as a reducible-metal compound build binder, e.g., copper nitrate, or a polymeric or polymerizable build binder, e.g., latex particle binder or polyurethane binder, for example, and can be ejected onto the copper-containing build material from a fluid ejector 210 to provide for selectively pattering the copper-containing build material. The location of the selective printing of the binding agent can be to a layer corresponding to a layer of a three-dimensional printed object, with information provided to print the respective layer provided by a three-dimensional (3D) object model or computer model.

A building temperature (T_{build}) or heat can be applied for building the green body object 220 in some examples, e.g., from 50° C. to 200° C., but other examples may not use heat when building the green body object. If heat is used, heat can be provided from a heat source 212 at the various layers (or group of layers, or after the green body object is formed) to (i) facilitate the build binder curing process, and/or (ii) remove solvent from the binding agent 110, which can assist with more rapid solidification of individual layers. Removing solvent from the binding agent can also reduce the wicking period of the binding agent outside of the printed object boundary and allow for a more precise printed green part. In one example, heat can be applied from overhead, e.g., prior to application of the next layer of copper-containing build material, or after multiple layers are formed, etc., and/or can be provided by the build platform from beneath the copper-containing build material and/or from the copper-containing build material source (preheating copper-containing build material prior to dispensing on the build platform or previously applied three-dimensional object layer). As metal can be very good conductors of heat, when applying heat from below, care can be taken to heat to levels that do not decompose the build binder, in some examples. After individual layers are printed with the binding agent, the build platform can be dropped a distance corresponding to a thickness of the applied layer of copper-containing build material, e.g., about 50 μm to about 200 μm, so that another layer of the copper-containing build material can be added thereon and printed with the binding agent, etc. The process can be repeated on a layer by layer basis until a green body object is formed that is stable enough to move to an oven suitable for fusing, e.g., sintering, annealing, melting, or the like.

With more specific details regarding the shaping composition 100, this composition, in some examples, can include a liquid vehicle, e.g., from about 10 wt % to about 80 wt % liquid vehicle, and metal shaping particles, e.g., from about 20 wt % to about 90 wt %. Thus, whether there is one or there are multiple types of metal shaping particles present, the total weight percentage can be from about 20 wt % to about 90 wt %, for example. In further detail, the shaping composition can also include a polymer shaping binder, a polymerizable shaping binder, and/or a reducible-metal compound shaping binder. If a shaping binder is included, it may be included at from about 0.01 wt % to about 10 wt %, for example. However, in some examples, the shaping composition may be prepared without a shaping binder.

The term “metal shaping particles” is defined herein to include elemental metal particles or metal alloy particles including a major component, e.g., from about 50 wt % to 100 wt % of an elemental metal. The metal interacts with the copper-containing build particles at a surface of the green body object to effectuate shaping, e.g., ameliorate deformation or even promote positive shaping, of the green body object during ramp up of a temperature in a fusing oven used to heat-fuse the green body object to form a heat-fused copper metal part, which may also have a metal coating thereon provided by the metal shaping particles.

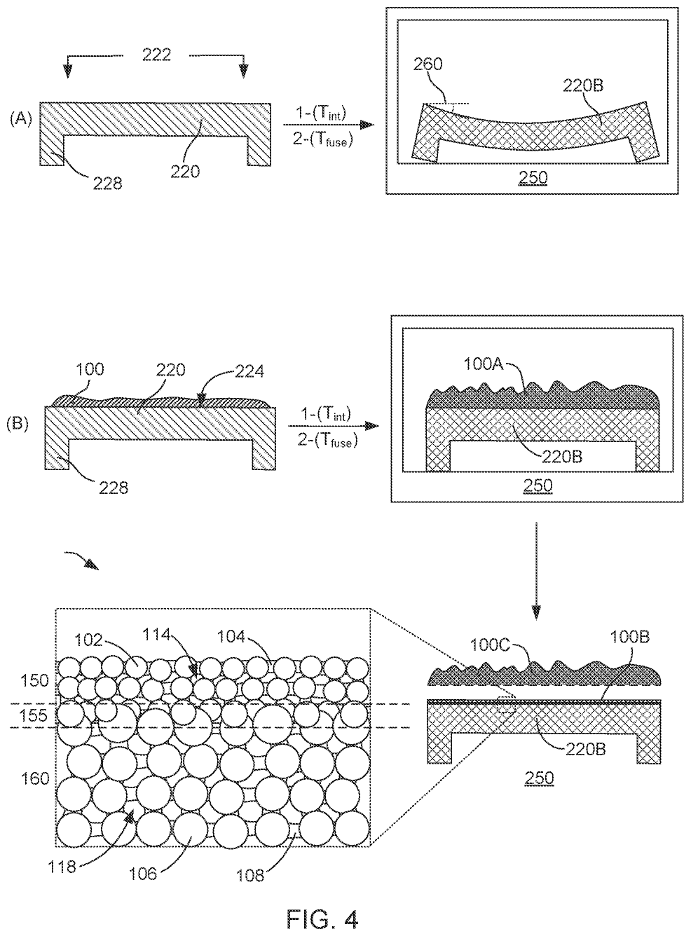

The metal shaping particles can have a D50 particle size distribution value from about 100 nm to about 100 μm, from about 1 μm to about 100 μm, from about 2 μm to about 75 μm, or from about 5 μm to about 50 μm, for example. As there are copper-containing build particles in the green body object, the metal shaping particles should not be confused with the particles used to form the green body object. In accordance with this, the metal shaping particles can be smaller than the copper-containing build particles. At a smaller particle size, the metal shaping particles can bond together earlier than the build particles. In examples herein, the shaping metal particles can be physically interactive with the copper-containing build particles to form an alloyed interface, which is described in greater detail in connection with FIG. 4 hereinafter. However, the metal shaping metal particles may be formulated into a shaping composition that is not exothermically reactive with the green body object, as might otherwise be the case if there were reactive metal complexes present, e.g., inorganic metal salt, organic metal salt, metal oxide, etc. Thus, in some examples, the shaping composition can be formulated to be devoid of exothermically reactive metal complexes. Furthermore, in addition to the elemental metals and alloys described herein, in the case of shaping particles that include an aluminum alloy, e.g., Al—Si—Mg. Al—Si, etc. alloyed metal particles (without other reactive components), there also is no exothermic reactivity at the surface of the green body object.

In further detail, Table 1 below provides a list of metals that can be used for the metal shaping particles, which can be elemental shaping particles, e.g., about 99 wt % to 100 wt % of a single elemental metal, or can be alloyed metal shaping particles, e.g., about 50 wt % to about 99 wt % of a single elemental metal alloyed with other metals and/or metalloids. Table 1 provides examples of elemental metals (other than silicon) that can be used as the metal shaping particles, or which can be used in alloyed metal shaping particles.

TABLE 1
Example Components of Metal Shaping Particles

| Metal or Metalloid Components | Melting Temperature (° C.) |
|---|---|
| Aluminum | 660 |
| Gold | 1063 |
| *Copper | 1083 |
| **Silicon | 1414 |
| Nickel | 1452 |
| Cobalt | 1495 |
| Iron | 1538 |
| Titanium | 1668 |
| Vanadium | 1910 |
| Chromium | 1930 |
| Molybdenum | 2623 |
| Tantalum | 3020 |
| Tungsten | 3422 |

*as the green body object is made from copper-containing build particles, the copper of the metal shaping particles will be different than the metal particles of the copper-containing build particles, e.g., smaller in size, and in some instances, may also have a different copper content.
**Silicon is a metalloid that can be alloyed with elemental metals to form metal shaping particles, e.g., Al—Si, Al—Si—Mg, etc.

Several different formulations of shaping compositions can be prepared using a liquid vehicle and one or more of these metal particles, as described herein. For example, there may even be a mixture of multiple types of metal particles, but in one example, the metal shaping particles may be included in the shaping composition as a single type of metal shaping particles.

To provide a few examples of more specific metal shaping particles that can be used, the metal shaping particles can be iron particles having a D50 particle size from about 1 μm to about 75 μm; nickel particles having a D50 particle size from about 100 nm to about 20 μm; high melting point alloyed metal particles selected from stainless steel particles, Ti—Al—V, or a combination thereof with the high melting point alloyed particles having a D50 particle size from about 1 μm 50 μm; and/or low melting point particles selected from copper particles, aluminum particles, Al—Si particles, Al—Si—Mg particles, or a combination thereof with the low melting point particles having a D50 particle size from about 100 nm to about 20 μm.

In some examples, the shaping composition can include a shaping binder (not shown), such as a reducible-metal compound shaping binder or a polymeric or polymerizable shaping binder. The term “shaping binder” is used to distinguish the binder used in the shaping composition from the binder that may be used in the binding agent used to form the green body object during a three-dimensional object build. Thus, the latter binder mentioned can be referred to as a “build binder,” as it is used to build the green body object. As the shaping binder and the build binder can be selected from a common list of compounds, e.g., polymer, reducible-metal compounds, etc., sometimes the simple term “binder” is used herein, but it is understood to be one or the other type of binder based on context. If the context allows for it to mean both types of binder, than the term can be applicable to both types of binder. As mentioned, in accordance with examples of the present disclosure, shaping compositions described herein can be applied to green body objects formed of metal particles on surfaces thereof at strategic locations and coating thickness, considering compositional makeup fusing temperature profiles, e.g., heat ramp-up timing to sintering temperatures, to counteract unwanted part sagging or other unwanted deformation. Thus, it can be said that undesirable deformations that can occur due to the heat-fusing process, e.g., due to gravity, can be counteracted by shaping composition-induced surface support provided by appropriate application of the shaping compositions described herein.

The liquid vehicle and the shaping binder (if present) can be similar to that which is used in fluids that are applied to copper-containing build particles and build binder used for printing three-dimensional green objects, which is described in greater detail hereinafter. Thus, the description of liquid vehicle as it relates to printing three-dimensional objects presented hereinafter is relevant to the shaping compositions, and that description is incorporated herein by reference. In short, however, liquid vehicle and build binder can be used to form a binding agent.

That stated, in short, the liquid vehicle of the shaping composition can be water or can be an aqueous liquid vehicle with water and other components, e.g., organic co-solvent, surfactant, biocide or fungicide, etc. The liquid vehicle can likewise be organic or non-aqueous, including from no water to de Minimis concentrations of water, e.g., up to 5 wt %. The build binder used in the binding agent can be a polymeric binder such as a latex binder, a polyurethane binder, or can be a reducible-metal compound binder, such as copper nitrate or other metal compound as described in greater detail hereinafter. Likewise, the shaping binder can be any of these types of binders, and can be present in the shaping composition at from about 2 wt % to about 30 wt %, from about 3 wt % to about 25 wt %, from about 3 wt % to about 20 wt %, from about 4 wt % to about 15 wt %, from about 2 wt % to about 10 wt %, or from about 2 wt % to about 8 wt %, for example. In further detail, the liquid vehicle can be present in the shaping composition at from about 10 wt % to about 80 wt %, from about 15 wt % to about 60 wt %, from about 20 wt % to about 50 wt %, or from about 25 wt % to about 50 wt %.

The shaping composition can be self-supporting and/or self-adhesive to a green body object, and in some instances, self-adhesive to a green body object when oriented in any direction, counteracting or holding to green body object surfaces with gravitational pull working against the shaping composition location relative to a surface of the green body object. Thus, the shaping composition (containing the metal shaping particles) can be in the form of a slurry having a viscosity from about 50 cps to about 5000 cps, from about 100 cps to about 4000 cps, from about 200 cps to about 2500 cps, from about 500 to about 800 cps, from about 800 cps to about 2000 cps, or from about 2000 cps to about 5000 cps, for example. The slurry can be spreadable or applied using any of a number of mechanical applicators, such as a roller, a hard tool such as a spackle applicator or a blade, a blade coater, a Meyer rod coater, etc. With less viscous compositions, sprayers, jetting architecture, dip coaters, curtain coaters, or brushes, or the like can be used to apply the shaping compositions. Example viscosities for these types of less viscous shaping compositions can be from about 50 cps to about 250 cps, from about 50 cps to about 100 cps, or from about 100 cps to about 500 cps, for example. Viscosities outside these ranges can be used as well. In some examples, the consistency of the slurry may be that of a paste, slurry, or have any other consistency that can be applied to the green body object and remain present during temperature ramp up in a heat fusing oven, for example. Example coating thickness for the shaping compositions can be from about ½ mm to about 10 mm, from about 1 mm to about 8 mm, or from about 2 mm to about 5 mm, though thickness outside of this range can also be used.

With these and/or other properties and in accordance with the present disclosure, when the shaping composition has the correct formulation, thickness, and/or the like, and/or is applied at an appropriate location(s), the metal particulate mixture in the shaping composition, applied as a coating to a surface of the green body object, can alloy at a surface of the green body object at a thickness ranging from about 1 μm to about 200 μm upon heat fusing of the green body object. The average thickness of the metal coating on the heat-fused metal object (beyond the alloyed interface) can be from about 100 μm to about 2 mm. In some examples, after forming the green body object with the metal coating and the alloyed metal interface, the metal coating can be ground off at a desired thickness, sometimes leaving a thickness of the metal coating, and sometimes removing the metal coating and leaving the alloyed metal interface without the neat metal coating thereon.

Deformation that occurs as a result of the shaping composition applied at a surface of the green body object can be referred to as “shaping composition-induced surface support,” as it is applied to the surface and supports the original structure during heat fusing. In one specific example, it is noted that the shaping composition can be used to control green body object deformation by introducing new shapes to the green body object, e.g. 4D printing. This can be done by varying the compositional makeup of the shaping composition, including thicker coatings, and/or by placing the shaping composition at locations not intended to reduce deformation, etc., to introduce a new formation or shape beyond the green body object configuration as printed or otherwise formed. Thus, the shaping compositions can be used to “control” the green body object by introducing new shapes to the green body object beyond that which could be used for shape retention while passing through or soaking within an intermediate temperature range. For clarity, when referring to “controlling green body object deformation” or “controlling deformation” or “deformation,” the deformation that is being controlled is something other than the natural sagging deformation that may occur when not using the shaping compositions of the present disclosure. Any other shaping that occurs is considered to be the result of “controlling” deformation, even if something other than what was initially formed during manufacture of the green body object occurs, e.g., reduced sagging, retaining general shape, positive shaping upward or along some other vector or direction caused by the presence of the shaping composition, etc. Thus, it is understood that deformation may include retaining the intended shape of a green body object, but may also include using the shaping compositions to introduce a new shape that is altered from the shape of the green body object as printed, e.g. introduce a bulge or a recess or an angle to a green body object that is different than the green body object as printed.

### Methods of Shaping and Heat-Fusing Green Body Objects

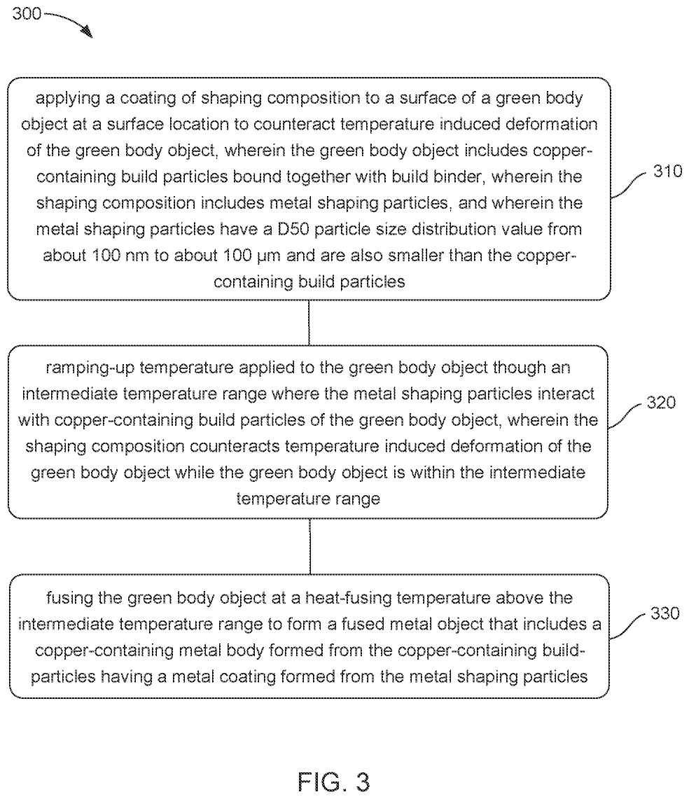

In an example of the present disclosure, and as shown in a flow diagram in FIG. 3, a method 300 of controlling green body object deformation can include applying 310 a coating of shaping composition to a surface of a green body object at a surface location to counteract temperature induced deformation of the green body object. The green body object can include copper-containing build particles bound together with build binder. The shaping composition can include metal shaping particles having a D50 particle size distribution value from about 100 nm to about 100 μm. The metal shaping particles can be smaller in average size than the copper-containing build particles. In further detail, the method can include ramping-up temperature 320 applied to the green body object though an intermediate temperature range where the metal shaping particles interact with copper-containing build particles of the green body object. The shaping composition counteracts temperature induced deformation of the green body object while the green body object is within the intermediate temperature range. The method can further include fusing 330 the green body object at a heat-fusing temperature above the intermediate temperature range to form a fused metal object that includes a copper-containing metal body formed from the copper-containing build-particles having a metal coating formed from the metal shaping particles.

In one specific example, the method can include forming the green body object by iteratively applying individual build material layers of a particulate build material including the copper-containing build particles, and based on a 3D object model, selectively applying a binding agent to individual build material layers to define individually patterned layers that are built up and bound together to form the green body object. This type of additive manufacturing is shown by way of example at FIG. 2 previously described. In another example, the method can include removing residual metal shaping particles after fusing leaving the metal coating applied on the copper-containing metal body at an average thickness where applied at from about 100 μm to about 2 mm with an alloyed interface from about 1 μm to about 200 μm in thickness. Removal may be by grinding, sand blasting, brushing, washing, etc., depending on the makeup and nature of the residual metal shaping particles present after heat fusing.

Fusing Green Body Objects with Shaping Composition-Induced Surface Support

Green body objects, such as those prepared using three-dimensional printing or other additive manufacturing, can be heat-fused to form fused metal objects. However, after forming the green body object, there is an opportunity for inducing deformation that may otherwise naturally occur in the heat fusing oven. For example, inducing deformation may include ameliorating deformation during heat-fusing or even generating shaping deformation to modify the shape from that which was printed or manufactured prior to heat-fusing the green body object to form the heat-fused metal object. As used herein “green body object” (as a complete object mass, plurality of object layers, or even an individual layer) refers to additive components including unfused metal particles and typically a build binder of some type held together in the form of a three-dimensional shape, but which has not yet been heat-fused, e.g., not heat sintered or annealed to fuse the metal particles together. As a green body, the copper-containing build material can be (weakly) bound together by a binding agent. Typically, a mechanical strength of the green body is such that the green body can be handled or extracted from a build platform to place in a fusing oven. It is to be understood that any copper-containing build material that is not patterned with the binding agent is not considered to be part of the green body, even if the copper-containing build material is adjacent to or surrounds the green body. For example, unprinted copper-containing build material can act to support the green body while contained therein, but the copper-containing build material is not part of the green body unless the copper-containing build material is printed with binding agent, or some other fluid that is used to generate a solidified part prior to fusing, e.g., sintering, annealing, melting, etc. Furthermore, green body objects tend to be somewhat fragile with rigidity lower than the metal part that is to be ultimately formed upon heat-fusing the green body object. Once the green part or green body object is fused, the part or body object can be referred to as a “fused metal object.”

The terms “fuse,” “fused,” “fusing,” or the like refers to stainless steel copper-containing build particles of a green body object that have become heat-joined at high temperatures, depending on a variety of variables, e.g., particle size, type of stainless steel, metal purity, weight percent of metal content, etc. Fusing may be in the form of melting, sintering, annealing, etc., of the metal particles, and can include a complete fusing of adjacent particles into a common structure, e.g., melting together, or can include surface fusing where particles are not fully melted to a point of liquefaction, but which allow for individual particles of the copper-containing build material to become bound to one another, e.g., forming material bridges between particles at or near a point of contact. Fusing can include particles becoming melted together as a unitary solid mass, or can include surfaces of copper-containing build particles becoming softened or melted to join together at particle interfaces. In either case, the copper-containing build particles become joined and the fused metal object can be handled and/or used as a rigid part or object without the fragility of the green body object.

Sintering of copper-containing build particles is one form of metal particle fusing. Annealing is another form of metal particle fusing. A third type of fusing includes melting copper-containing build particles together to form a unitary mass. The terms “sinter,” “sintered,” “sintering,” or the like refer to the consolidation and physical bonding of the copper-containing build particles together (after temporary binding using the binding agent) by solid state diffusion bonding, partial melting of copper-containing build particles, or a combination of solid state diffusion bonding and partial melting. The term “anneal” refers to a heating and cooling sequence that controls the heating process, and the cooling process, e.g., slowing cooling in some instances, to remove internal stresses and/or toughen the fused metal object.

When sintering or annealing, in most typical examples, an acceptable sintering temperature range for copper may be from about 900° C. to about 1065° C., depending on the grade of copper used and/or if the copper is alloyed with other elements, considering elemental metal ratios, impurities, particle size, time of heat soak, etc. For elemental copper, e.g., about 99 wt % to 100 wt % elemental copper, the temperature range for heat fusing, e.g., sintering or annealing, can be from about 980° C. to about 1075° C. In further detail, if sintering or annealing, based on the copper-containing build particles used, the temperature selected for use can vary, but in one example, the sintering temperature can range from about 10° C. below the melting temperature of the copper-containing build particles to about 100° C. below the melting temperature of the copper-containing build material (with time sintering or soaking, material purity, etc., being considered). In one example, a temperature can be used during a heat soak period to sinter and/or otherwise fuse the copper-containing build particles to form the fused metal object. Heat soaking time frames for sintering can be from about 5 minutes to about 2 hours, from about 10 minutes to about an hour, or from about 15 minutes to about 45 minutes, for example.

When heating green body objects, the temperature within the fusing oven can be raised from an initial temperature, T₀, to an intermediate temperature, Tᵢₙₜ, during heat ramp-up, to a heat-fusing temperature, T_{fuse}, to heat-fuse the copper-containing build particles. While ramping-up the temperature, and even in some cases while at heat-fusing temperatures, green body objects that include cantilevered portions or portions that span multiple supports can sag with temperature increase. To show this effect, FIG. 4 depicts two green body objects 220 that are three-dimensionally printed using copper or a copper alloy. These objects are examples of structures used to illustrate sagging compared to the amelioration of sagging. Thus, spanned regions 222 of these objects shown are about 28 mm with a vertical thickness of about 4.5 mm and a horizontal thickness of about 6 mm. These spanned regions are supported by legs 228 positioned at opposing distal ends of the spanned region. The green body objects are placed in a fusing oven 250 and ramped up in temperature to fuse the green body to form a fused metal object 220B. The samples are heated through an intermediate temperature, Tᵢₙₜ, short of a target heat-fusing temperature, T_{fuse}, and then heat-fused at a sintering temperature where the object may be heat soaked for 30 minutes to 4 hours. As shown at (A) where no shaping composition is applied, the object becomes deformed as the spanned region sags, as there is not enough support to retain the shape of the green body object while ramping up through the intermediate temperatures. An angle of deflection 260 is shown, which can vary, depending on the materials and dimension of the object, e.g., from about 1° to about 30° (or more). For example, a vertically oriented pillar may sag and fall completely over within intermediate temperatures during ramp up, which would be a 90° angle of deflection from the original shape.

In further detail, as shown at (B), a shaping composition 100, such as one of the shaping compositions described herein, can be applied as a slurry to a top surface 224 of the green body object 220 (or any other surface to cause shaping as desired). After passing through intermediate temperatures and then to sintering temperatures, the fused metal object 220B retains its shape. The residual shaping composition 110A in this example can be removed (as shown at 100C) mechanically, such as by brushing, grinding, sand blasting, washing, etc., depending on the nature of the residual shaping metal particles used. As also shown at the exploded view of (B), after removal of a portion of the residual shaping metal particles remaining after sintering, the shaping metal particles originally present in the shaping composition become heat-fused metal shaping particles 102 with particle-to-particle necking 104 (metallurgic inter-particle bridges) with typically a small void volume 114 remaining. Likewise, the copper-containing build particles originally used to form the green body object become heat-fused copper-containing metal build particles 106 with particle-to-particle necking 108 and a void volume 118. As can be seen the void volumes are different in the heat-fused metal object body 160 compared to the heat-fused metal coating 150. Thus, the volume density of the heat-fused metal object body may be different, e.g., either greater volume density or lower volume density, than the heat-fused metal coating. Also, heat fusing the green body object with the shaping composition thereon, a metal alloy can also be present where alloys or mixtures of the various types and/or sizes of heat-fused metal particles can form an interface layer 155 from about 1 μm to about 200 μm in thickness.

### Binders

There are two compositions described herein that can utilize a binder in accordance with the present disclosure, e.g., the build binder in the binding agent used for the three-dimensional printing kit and/or three-dimensional printing processes described herein and the shaping binder that may be present in the shaping composition. With respect to build binder, a binding agent can include a liquid vehicle and a build binder. The build binder can be carried by a liquid vehicle for jetting from jetting architecture, for example. The build binder can be present in the binding agent at from about 1 wt % to about 30 wt %, for example. With shaping composition, the shaping binder can be co-dispersed with metal particles and may also include a liquid vehicle to form a slurry, for example. The shaping binder can be present in the shaping composition at from about 2 wt % to about 30 wt %, or at the other weight ranges previously described, for example. Thus, the description of the “binder” (or binder compound) herein is relevant to both build binder found in binding agents as well as shaping binder found in shaping compositions. When describing “binder,” it is understood to include a description of both types of binder.

Regarding the binder, any of a number of binders can be used, including metal binders or polymeric binders. In other words, the term “binder” or “binder compound” can include any material used to physically bind metal particles together initially, but often for a period of time during heating in a fusing oven or furnace. With specific reference to metal binder, the metal can be in the form of a reducible-metal compound binder. To illustrate, the copper-containing build particles can be bound together using the reducible-metal compound binder which may be an iron oxide or salt, a chromium oxide or salt, or a copper oxide, for example. The reducible-metal compound binder can be reduced by hydrogen released from a thermally activated reducing agent in some examples. More general examples of reducible-metal compound binders can include metal oxides (from one or multiple oxidation states), such as a copper oxide, e.g., copper (I) oxide or copper (II) oxide; an iron oxide, e.g., iron(I) oxide or iron(III) oxide; an aluminum oxide, a chromium oxide, e.g., chromium(IV) oxide; titanium oxide, a silver oxide, zinc oxide, etc. As a note, due to variable oxidation states, transition metals can form various oxides in different oxidation states, e.g., transition metals can form oxides of different oxidation states. Other examples can include organic or inorganic metal salts. In particular, inorganic metal salts that can be used include metal bromides, metal chlorides, metal nitrates, metal sulfates, metal nitrites, metal carbonates, or a combination thereof. Organic metal salts can include chromic acid, chrome sulfate, cobalt sulfate, potassium gold cyanide, potassium silver cyanide, copper cyanide, copper sulfate, nickel carbonate, nickel chloride, nickel fluoride, nickel nitrate, nickel sulfate, potassium hexahydroxy stannate, sodium hexahydroxy stannate, silver cyanide, silver ethansulfonate, silver nitrate, sodium zincate, stannous chloride (or tin(II) chloride), stannous sulfate (or tin(II) sulfate, zinc chloride, zinc cyanide, or tin methansulfonate, for example. In some instances, the reducible-metal compound binder can be in the form of a nanoparticle, and in other instances, the reducible-metal compound binder can be disassociated or dissolved in the aqueous liquid vehicle. As particles, the reducible-metal compound binder can have a D50 particle size from about 10 nm to about 10 μm, from about 10 nm to about 5 μm, from about 10 nm to about 1 μm, from about 15 nm to about 750 nm, or from about 20 nm to about 400 nm.

Metal binder can be reducible as a result of introduced atmosphere with a reducing agent, and/or can be thermally activated, for example. Thermally activated reducing agent that can be used may be sensitive to elevated temperatures. Example thermally activated reducing agents can include hydrogen (H₂), lithium aluminum hydride, sodium borohydride, a borane (e.g., diborane, catecholborane, etc.) sodium hydrosulfite, hydrazine, a hindered amine, 2-pyrrolidone, ascorbic acid, a reducing sugar (e.g., a monosaccharide), diisobutylaluminium hydride, formic acid, formaldehyde, or mixtures thereof. The choice of reducing agent can be such that it is thermally activated at a temperature, or can be introduced at a temperature where reduction of the metal binder may be desired. By way of example, if considering using a metal oxide nanoparticle as the reducible-metal compound binder, there may be metal oxides that are stable (or relatively unreactive) at room temperature, but upon application of heat, e.g., 200° C. to 1000° C. or 250° C. to 1000° C. or from 300° C. to 700° C., a redox-reaction can result in the production of the pure metal or metal alloy. As an example, mercury oxide or silver oxide can be reduced to their respective elemental metal by heating to about 300° C., but the presence of a reducing agent may allow the reaction to occur at a lower temperature, e.g., about 180° C. to about 200° C. Oxides of more reactive metals like zinc, iron, copper, nickel, tin, or lead may likewise be reduced simply in the presence of a reducing agent, so the reducing agent can be introduced into the fusing oven or furnace at a time where binding properties may be beneficial. Reducing agents, whether thermally activated or reactive without added temperature can be capable of providing hydrogen moieties completing the redox-reaction at elevated temperatures in accordance with examples of the present disclosure. An example of one reaction is shown in Formula 1, as follows:

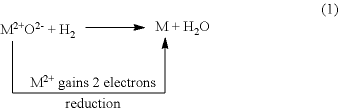

In other examples, the binder or binder compound can be a polymeric binder, such as latex particles, for example. The polymer binder or polymerizable binder can be a polymer that can have different morphologies. In one example, the polymer binder or polymerizable binder can include a uniform composition, e.g. a single monomer mixture, or can include two different compositions, e.g. multiple monomer compositions, copolymer compositions, or a combination thereof, which may be fully separated core-shell polymers, partially occluded mixtures, or intimately comingled as a polymer solution. In another example, the polymer binder or polymerizable binder can be individual spherical particles containing polymer compositions of hydrophilic (hard) component(s) and/or hydrophobic (soft) component(s). For example, a core-shell polymer can include a more hydrophilic shell with a more hydrophic core or a more hydropobic shell with a more hydrophillic core. With respect to “more hydrophillic” and “more hydrophobic” the term more is a relative term that indicates a hydrophillic or hydrophobic property when considering the core composition and the shell composition in respect to one another.

In some examples, the polymer binder or polymerizable binder can include latex particles. The latex particles can include 2, 3, or 4 or more relatively large polymer particles that can be attached to one another or can surround a smaller polymer core. In a further example, the latex particles can have a single phase morphology that can be partially occluded, can be multiple-lobed, or can include any combination of any of the morphologies disclosed herein. In some examples, the latex particles can be produced by emulsion polymerization. The latex particles in the binding agent can include polymerized monomers of vinyl, vinyl chloride, vinylidene chloride, vinyl ester, functional vinyl monomers, acrylate, acrylic, acrylic acid, hydroxyethyl acrylate, methacrylate, methacrylic acid, styrene, substituted methyl styrenes, ethylene, maleate esters, fumarate esters, itaconate esters, α-methyl styrene, p-methyl styrene, methyl (meth)acrylate, hexyl acrylate, hexyl (meth)acrylate, butyl acrylate, butyl (meth)acrylate, ethyl acrylate, ethyl (meth)acrylate, propyl acrylate, propyl (meth)acrylate, 2-ethylhexyl acrylate, 2-ethylhexyl (meth)acrylate, isodecyl (meth) acrylate, octadecyl acrylate, octadecyl (meth)acrylate, stearyl (meth)acrylate, vinylbenzyl chloride, isobornyl acrylate, isobornyl (meth)acrylate, tetrahydrofurfuryl acrylate, tetrahydrofurfuryl (meth)acrylate, 2-phenoxyethyl (meth)acrylate, benzyl (meth)acrylate, benzyl acrylate, ethoxylated nonyl phenol (meth)acrylate, isobornyl (meth)acrylate, cyclohexyl (meth)acrylate, trimethyl cyclohexyl (meth)acrylate, t-butyl (meth)acrylate, n-octyl (meth)acrylate, lauryl (meth)acrylate, tridecyl (meth)acrylate, alkoxylated tetrahydrofurfuryl acrylate, alkoxylated tetrahydrofurfuryl (meth)acrylate, isodecyl acrylate, isobornyl methacrylate, isobornyl acrylate, dimethyl maleate, dioctyl maleate, acetoacetoxyethyl (meth)acrylate, diacetone acrylamide, diacetone (meth)acrylamide, N-vinyl imidazole, N-vinylcarbazole, N-vinyl-caprolactam, combinations thereof, derivatives thereof, or mixtures thereof. These monomers include low glass transition temperature (Tg) monomers that can be used to form the hydrophobic component of a heteropolymer.

In other examples, the latex particles can include acidic monomers that can be used to form the hydrophilic component of a heteropolymer. Example acidic monomers that can be polymerized in forming the latex particles can include acrylic acid, methacrylic acid, ethacrylic acid, dimethylacrylic acid, maleic anhydride, maleic acid, vinylsulfonate, cyanoacrylic acid, vinylacetic acid, allylacetic acid, ethylidineacetic acid, propylidineacetic acid, crotonoic acid, fumaric acid, itaconic acid, sorbic acid, angelic acid, cinnamic acid, styrylacrylic acid, citraconic acid, glutaconic acid, aconitic acid, phenylacrylic acid, acryloxypropionic acid, aconitic acid, phenylacrylic acid, acryloxypropionic acid, vinylbenzoic acid, N-vinylsuccinamidic acid, mesaconic acid, methacroylalanine, acryloylhydroxyglycine, sulfoethyl methacrylic acid, sulfopropyl acrylic acid, styrene sulfonic acid, sulfoethylacrylic acid, 2-methacryloyloxymethane-1-sulfonic acid, 3-methacryoyloxypropane-1-sulfonic acid, 3-(vinyloxy)propane-1-sulfonic acid, ethylenesulfonic acid, vinyl sulfuric acid, 4-vinylphenyl sulfuric acid, ethylene phosphonic acid, vinyl phosphoric acid, vinyl benzoic acid, 2-acrylamido-2-methyl-1-propanesulfonic acid, sodium 1-allyloxy-2-hydroxypropane sulfonate, combinations thereof, derivatives thereof, or mixtures thereof. In some examples, the acidic monomer content can range from about 0.1 wt % to about 15 wt %, from about 0.5 wt % to about 12 wt %, or from about 1 wt % to about 10 wt % of the latex particles with the remainder of the latex particles being composed of non-acidic monomers. In some examples the acid monomer can be concentrated towards an outer surface of a latex particle.

The latex particles can have various molecular weights, sizes, glass transition temperatures, etc. In one example, the polymer in the latex particles can have a weight average molecular weight ranging from about 10,000 Mw to about 500,000 Mw, from about 100,000 Mw to about 500,000 Mw, or from about 150,000 Mw to about 300,000 Mw. The latex particles can have a particle size that can be jetted via thermal ejection or printing, piezoelectric ejection or printing, drop-on-demand ejection or printing, continuous ejection or printing, etc. In an example, the particle size of particles of the polymer binder or polymerizable binder can range from about 10 nm to about 400 nm. In yet other examples, a particle size of polymer binder or polymerizable binder can range from about 10 nm to about 300 nm, from about 50 nm to about 250 nm, from about 100 nm to about 300 nm, or from about 25 nm to about 250 nm. In some examples, the latex particle can have a glass transition temperature that can range from about −20° C. to about 130° C., from about 60° C. to about 105° C., or from about 10° C. to about 110° C.

### Liquid Vehicles

Liquid vehicles described herein can refer to the liquid vehicle used for the jettable binding agent of the liquid component of the liquid used in the shaping composition. As an initial matter, the shaping composition can be a liquid vehicle of water. In other examples, there can be other components along with the water, such as organic co-solvent, surfactant, biocide, etc. The liquid vehicle in the shaping composition can be included at from about 10 wt % to about 80 wt %, from about 15 wt % to about 60 wt %, from about 20 wt % to about 50 wt %, or from about 25 wt % to about 50 wt %, for example. Other percentages of the liquid vehicle, such as water or water and other liquid components, can be used, depending on how the shaping composition is to be applied, e.g., dipping, spraying, etc., and may include more liquid vehicle component, whereas spreading of a more viscous composition may include less liquid vehicle component. In further detail, many of the components described below with respect to the binding agent can likewise be used in formulating the liquid vehicle of the shaping composition, and those components are incorporated herein by reference.

Regarding the jettable binding agent, there can be some care taken with respect to formulating a binding agent that is jettable, particularly if it is to be thermally jettable. In this example, the binding agent can include a build binder dispersed in an aqueous vehicle, such as a vehicle including water as a major solvent, e.g., the solvent present at the highest concentration compared to other co-solvents. Apart from water, the aqueous vehicle can include organic co-solvent(s), such as high-boiling solvents and/or humectants, e.g., aliphatic alcohols, aromatic alcohols, alkyl diols, glycol ethers, polyglycol ethers, 2-pyrrolidinones, caprolactams, formamides, acetamides, and long chain alcohols. Some other more specific example organic co-solvents that can be included in the binding agent can include aliphatic alcohols, 1,2-alcohols, 1,3-alcohols, 1,5-alcohols, ethylene glycol alkyl ethers, propylene glycol alkyl ethers, higher homologs (C6-C12) of polyethylene glycol alkyl ethers, N-alkyl caprolactams, unsubstituted caprolactams, substituted formamides, unsubstituted formamides, substituted acetamides, unsubstituted acetamides, and combinations thereof. Some water-soluble high-boiling solvents can act as coalescing aids for latex particles. Example water-soluble high-boiling solvents can include propyleneglycol ethers, dipropyleneglycol monomethyl ether, dipropyleneglycol monopropyl ether, dipropyleneglycol monobutyl ether, tripropyleneglycol monomethyl ether, tripropyleneglycol monobutyl ether, dipropyleneglycol monophenyl ether, 2-pyrrolidinone and 2-methyl-1,3-propanediol. The organic co-solvent(s) in aggregate can include from 0 wt % to about 50 wt % of the binding agent. In some examples, co-solvents can be present at from about 5 wt % to about 25 wt %, from about 2 wt % to about 20 wt %, or from about 10 wt % to about 30 wt % of the binding agent. In some examples, the binding agent can further include from about 0.1 wt % to about 50 wt % of other liquid vehicle components. These liquid vehicle components can include other organic co-solvents, additives that inhibit growth of harmful microorganisms, viscosity modifiers, pH adjusters, sequestering agents, surfactants, preservatives, etc. Regardless of the formulation, the aqueous vehicle can be present in the binding agent at from about 20 wt % to about 98 wt %, from about 70 wt % to about 98 wt %, from about 50 wt % to about 90 wt %, or from about 25 wt % to about 75 wt.

Some example liquid vehicle components that can inhibit the growth of harmful microorganisms that can be present can include biocides, fungicides, and other microbial agents, which are routinely used in ink formulations. Commercially available examples can include ACTICIDE® (Thor GmbH), NUOSEPT® (Troy, Corp.), UCARCIDE™ (Dow), VANCIDE® (R.T. Vanderbilt Co.), PROXEL® (Arch Biocides), and combinations thereof.

### Copper-Containing Build Materials

The copper-containing build material can include copper-containing build particles of any type that can be fused together at a heat-fusing temperature (above the temperature at which the green body is formed). Fusing can be carried out at heat-fusing temperatures by sintering, annealing, melting, or the like, so that the copper-containing build particles can be solidified together to for a metal three-dimensional object.

In one example, the copper-containing build material can include from about 80 wt % to 100 wt % of the copper-containing build particles based on a total weight of the copper-containing build material.

In an example, the copper-containing build particles can be a single phase metallic material composed of one alloy, e.g., copper and secondary metals or metalloids, as a single phase metallic alloy. Thus, there may be various particles as alloys, or a multiple phase metallic alloy, e.g. different particles can include different metals, in the form of composites, e.g., core-shell metal particles. In these examples, fusing generally can occur over a range of temperatures. In some examples, the copper-containing build particles of the build material can include other particles, e.g., up to 20 wt %, of elemental metals or alloys of titanium, cobalt, chromium, nickel, vanadium, tungsten, tantalum, molybdenum, iron, stainless steel, steel, or an admixture thereof. In one example, the copper-containing build particles can be copper or a copper alloy, for example.

The D50 particle size of the copper-containing build particles can range from about 1 μm to about 150 μm. In some examples, the particles can have a D50 particle size distribution value that can range from about 10 μm to about 100 μm, from about 20 μm to about 150 μm, from about 15 μm to about 90 μm, or from about 50 μm to about 150 μm. Individual particle sizes can be outside of these ranges, as the “D50 particle size” is defined as the particle size at which half of the particles are larger than the D50 particle size and about half of the other particles are smaller than the D50 particle size (by weight based on the metal particle content of the copper-containing build material).

As used herein, particle size can refer to a value of the diameter of spherical particles or in particles that are not spherical can refer to a longest dimension of that particle. The particle size can be presented as a Gaussian distribution or a Gaussian-like distribution (or normal or normal-like distribution). Gaussian-like distributions are distribution curves that can appear Gaussian in their distribution curve shape, but which can be slightly skewed in one direction or the other (toward the smaller end or toward the larger end of the particle size distribution range). That being stated, an example Gaussian-like distribution of the copper-containing build particles can be characterized generally using “DIG,” “D50,” and “D90” particle size distribution values, where D10 refers to the particle size at the 10^{th} percentile, D50 refers to the particle size at the 50^{th} percentile, and D90 refers to the particle size at the 90^{th} percentile. For example, a D50 value of 25 μm means that 50% of the particles (by number) have a particle size greater than 25 μm and 50% of the particles have a particle size less than 25 μm. Particle size distribution values may not be related to Gaussian distribution curves, but in one example of the present disclosure, the copper-containing build particles can have a Gaussian distribution, or more typically a Gaussian-like distribution with offset peaks at about D50. In practice, true Gaussian distributions are not typically present, as some skewing can be present, but still, the Gaussian-like distribution can be considered to be “Gaussian” as used in practice. The shape of the particles of the copper-containing build material can be spherical, non-spherical, random shapes, or a combination thereof.

### Definitions

It is noted that, as used in this specification and the appended claims, the singular forms “a,” “an,” and “the” include plural referents unless the content clearly dictates otherwise.

The term “about” as used herein, when referring to a numerical value or range, allows for a degree of variability in the value or range, for example, within 10%, or, in one aspect within 5%, of a stated value or of a stated limit of a range. The term “about” when modifying a numerical range is also understood to include as one numerical subrange a range defined by the exact numerical value indicated, e.g., the range of about 1 wt % to about 5 wt % includes 1 wt % to 5 wt % as an explicitly supported sub-range.

As used herein, “kit” can be synonymous with and understood to include a plurality of compositions including multiple components where the different compositions can be separately contained in the same or multiple containers prior to and during use, e.g., building a three-dimensional object, but these components can be combined together during a build and/or shaping process. The containers can be any type of a vessel, box, or receptacle made of any material. Alternatively, a kit may be generated during the process of three-dimensional building a portion at a time. For example, the copper-containing build material can be decontaminated a layer at a time to form a “kit” of a decontaminated (portion) or a copper-containing build material that, when combined with the binding agent to be ejected thereon, completes the kit, e.g., a layer of decontaminated build material formed on a build platform or support bed is considered to be a kit when combined with a binding agent loaded in a three-dimensional printing system for ejection thereon.

As used herein, a plurality of items, structural elements, compositional elements, and/or materials may be presented in a common list for convenience. However, these lists should be construed as though the individual member of the list is identified as a separate and unique member. Thus, no individual member of such list should be construed as a de facto equivalent of any other member of the same list based on their presentation in a common group without indications to the contrary.

Concentrations, dimensions, amounts, and other numerical data may be presented herein in a range format. It is to be understood that such range format is used merely for convenience and brevity and should be interpreted flexibly to include the numerical values explicitly recited as the limits of the range, as well as to include all the individual numerical values or sub-ranges encompassed within that range as the individual numerical value and/or sub-range is explicitly recited. For example, a weight ratio range of about 1 wt % to about 20 wt % should be interpreted to include the explicitly recited limits of 1 wt % and 20 wt % and to include individual weights such as about 2 wt %, about 11 wt %, about 14 wt %, and sub-ranges such as about 10 wt % to about 20 wt %, about 5 wt % to about 15 wt %, etc.

### EXAMPLES

The following illustrates examples of the present disclosure. However, it is to be understood that the following is illustrative of the application of the principles of the present disclosure. Numerous modifications and alternative compositions, methods, and systems may be devised without departing from the spirit and scope of the present disclosure. The appended claims are intended to cover such modifications and arrangements.

### Example 1—Green Body Object Sample Preparation

Multiple green body objects of various sizes were prepared using a three-dimensional printing process similar to that shown in FIGS. 2-4. The shapes prepared included supports on two opposite sides with a spanned region there between to evaluate the effect of gravity-induced deformation or sagging during heating, and the ameliorating of sagging during heating using shaping compositions in accordance with the present disclosure. The structures prepared included 28 mm spanned regions with a vertical thickness of about 4.5 mm and horizontal thickness of about 6 mm. The green body objects formed were prepared using 99 wt % pure copper particles having a D50 particle size of about 50 μm (or slightly less). The binding agent used to form the green body object was a copper nitrate binder, heat cured in a layer-by-layer basis, and then cured after formation of the green body objects at about 70° C. to about 90° C., which provided sufficient green body object strength to move into a fusing oven.

### Example 2—Preparation of Shaping Composition with Polymer Shaping Binder

Five different shaping compositions were prepared using water as the liquid vehicle, as set forth in Table 2 below:

TABLE 2
Example Metal Particle Formulations

| | | | Metal Shaping |
|---|---|---|---|
| | Metal Shaping | D50 Particle | Particle Content |
| Formulation ID | Particles | Size (μm) | (wt %) |
| 1 | ¹Aluminum | 5 | 1-10 |
| 2 | ²Al—Si—Mg Alloy | 15-45 | 1-10 |
| 3 | ³Nickel | 10 | 1-10 |
| 4 | ⁴Iron | <60 | 1-10 |
| 5 | ⁵Stainless Steel | 15-45 | 1-10 |
| 6 | ⁶Ti6Al4V | 15-45 | 1-10 |
| 7 | ⁶Ultrafine Copper | <10 | 1-10 |

¹99.5 wt % Aluminum.
²Aluminum (balance); Silicon 9-11 wt %, Iron 0.55 wt % (max); Manganese 0.45 wt % (max); Magnesium 0.2-0.45 wt %, Titanium 0.15 wt % (max); Zinc 0.1 wt % (max); Copper 0.05 wt % (max); Lead 0.05 wt % (max); Nickel 0.05 wt % (max); and Tin 0.05 wt % (max).
³Nickel (balance); Carbon 0.01 wt %; Oxygen 0.33 wt %; Iron 0.12 wt %; Sulfur 0.003 wt %.
⁴Iron (balance); Carbon 3 wt % (max); Silicon 5 wt % (max); Phosphorus 5 wt % (max); and Manganese 1 wt % (max).
⁵Iron (balance); Chromium 16-18 wt %; Nickel 10-14 wt %; Molybdenum 2-3 wt %; Manganese 2 wt % (max); Silicon 1 wt % (max); Phosphorus 0.045 wt % (max); Carbon 0.03 wt % (max); and Sulfur 0.03 wt % (max).
⁶Titanium 90 wt %; Aluminum 6 wt %; and Vanadium 4 wt %.
⁷ 99.9 wt % Copper.

The metal particles set forth in Table 2 were shaped using water for this experiment, but in some examples, could be shaped or printed using a binding agent of about 25 wt % of a latex dispersion to provide about 5 wt % latex binder particle content, for example. The shaping composition is thus in the form of a thickened slurry. Notably, other levels of shaping binder content and/or metal particles can be used that may also be sufficient to generate a slurry.

### Example 3—Green Body Object Gravity-induced Deformation During Sintering

A green body object was prepared and sintered without the use of any shaping composition to determine how much deformation would occur. Once the green body objects were printed, the green body objects were placed in a fusing oven, ramped up through intermediate temperatures to arrive at a sintering temperature of about 1380° C., where the object was heat soaked for 2 hours. More specifically, the heating profile was as follows: heating at 5° C./min from room temperature to 170° C.→heating at 2.5° C./min to 300° C.→1 hour hold at 300° C. (heat soaking)→heating at 2.5° C./min to 500° C.→2 hour hold at 500° C. (heat soaking)→heating at 2.5° C./min to 650° C.→1 hour hold at 650° C. (heat soaking)→heating at 2.5° C./min to 1000° C.→30 minute hold at 1000° C. (heat soaking)→heating at 2.5° C./min to 1040° C.→4 hours hold at 1040° C. (heat soaking). Note that 30 minute hold at 1000° C. may or may not be used in this protocol. The atmosphere of the sintering oven was ArH₂. The heat-fused metal object formed exhibited significant sagging, with a deflection of about 13°, and the sample that was 2.8 mm thick along the spanned region exhibited a deflection (where the center of the spanned region sagged so much that it touched the floor or the fusing oven.

### Example 4—Reduction of Green Body Object Gravity-induced Deformation or Generating Positive Shaping (Upward Bowing) Using Shaping Composition Shaping Compositions of Table 2

In this example, the same procedure set forth in Example 3 was carried out, except that from about 0.2 to 0.5 g of the slurry containing the shaping metal particles of Table 2 were used to determine the effectiveness of deformation amelioration provided by the seven shaping metal particles. In this example, the various shaping compositions were applied evenly along a top surface of the spanned region and then dried by placing the green body object on a hot plate at 90° C. for about 10 to 15 minutes before loading into the fusing oven. After heat fusing in accordance with that described in Example 3, the solid copper part was evaluated to determine the effect of the shaping composition of the deformation compared to the control part where no shaping part was used. The results are provided in Table 3, as follows:

TABLE 3
Characterization of Amelioration of Gravity-induced Deformation

| | Metal Shaping | Impact on Amelioration of |
|---|---|---|
| Formulation ID | Particles | Deformation |
| 1 | ¹Aluminum | Retained Shape |
| 2 | ²Al—Si—Mg Alloy | Upward Bow |
| 3 | ³Nickel | Very Slight Central Sag |
| 4 | ⁴Iron | Retained Shape |
| 5 | ⁵Stainless Steel | Upward Bow |
| 6 | ⁶Ti6Al4V | Upward Bow |
| 7 | ⁶Ultrafine Copper | ~90% Reduction in Sag* |
| | | (center did not touch floor of oven) |

*Using a part with a 20 mm spanned region, the ultrafine copper particles was powerful enough to prevent distortion of the metal object

Regarding the use of Formulation 1, which has a lower melting temperature than the copper particles of the green body object, e.g., aluminum starts to melt at 660° C., and thus by the time copper starts to sinter at about 980° C. in this instance, the green body object as the temperature is being ramped ups retains its shape better than the control object of Example 3. Al—Si—Mg found in Formulation 2, on the other hand, pulls on the spanned region earlier during temperature ramp up, e.g., as the Al—Si—Mg starts to melt at 570° C. Thus, at about 570° C., the copper-containing green body object had not solidified as much as it did in the aluminum example, and thus, the upward pull occurred when the object was not as strong. In other words, at about 660° C., the green body object started to exhibit more solidification so at that point, the object tended to become more inherently solid and stronger. Thus, the shaping composition of Formula 1 was well matched with the solidification of the green body object, whereas the Formula 2 shaping composition was too powerful (by compositional interaction at the surface, by the earlier melting temperature, or both) that the result was an upwardly bowed spanned region, e.g., the spanned region forms a positive arc or upward bow above the original shape of the green body object. This can be referred to as positive shaping. If the goal is to modify the shape beyond that which was printed, then this may be the desired result in some instances.

Regarding some of the other shaping compositions, such as those of Formulations 3-6, the metals of these shaping compositions have higher melting points compared to copper. For example, Ti—Al—V melts at about 1600° C. However, the sintering of titanium on the surface of the copper-containing green body object exhibits sufficient upward pull at the amounts used to overcorrect against the sag, generating an upward bow along the spanned region (again which may be desirable in some instance). The same was true for the use of stainless steel. However, in the case of nickel and iron, in these examples, the shaping compositions were about right in retaining the shape of the green body object.

These metal coatings prepared can leave a metal crust on the surface that may alloy into a surface of the heat fused body of the metal object. For example, the metal coating can bind firmly to the part and provides strength to minimize distortion. So the mechanism by which these materials prevent sagging may be different than those of the shaping metal particles with lower melting temperatures compared to copper. With respect to Ti—Al—V alloy and stainless steel alloy generating an upward bow or positive shaping, this may be attributed to the relative sintering rates of the metal coatings and the copper green body object that has become a heat-fused copper object.

Regarding the ultrafine copper particles used in Formulation 7, reduction of sagging occurred by virtue of the particle size of the copper particles being significantly smaller than the copper build material particles (about 5 times smaller). These particles began to sinter and coalesce at lower temperatures due to the higher surface area, and thus, protected the three-dimensional object from sagging as well.

Overall, the results show that the judicious use of shaping composition applied to the green body object can be used to retain shape, and in some cases with some materials and compositions, positive shaping or overcorrection can occur beyond the shape of the original green body object that was printed, again which may be the desired result in some instances. Thus, machining the correct shaping composition, location of application, thickness of application, concentration of shaping metal particles, etc., can be carried out to achieve a range of results ranging from reduced sagging, to retaining original shape, to generating a positive shaping beyond the original shape.

What is claimed is:

1. A three-dimensional printing kit comprising:
a particulate build material comprising about 80 wt % to 100 wt % copper-containing build particles having a D50 particle size distribution value from about 1 μm to about 150 μm;
a binding agent including a build binder to apply to particulate build material layers to form a green body object; and
a shaping composition to apply to a surface of the green body object and to control green body object deformation, the shaping composition including from about 10 wt % to about 80 wt % liquid vehicle and from about 20 wt % to about 90 wt % metal shaping particles having a D50 particle size distribution value from about 100 nm to about 100 μm that is also smaller than the copper-containing build particles.

2. The three-dimensional printing kit of claim 1, wherein the metal shaping particles are iron particles having a D50 particle size from about 1 μm to about 75 μm.

3. The three-dimensional printing kit of claim 1, wherein the metal shaping particles are nickel particles having a D50 particle size from about 100 nm to about 20 μm.

4. The three-dimensional printing kit of claim 1, wherein the metal shaping particles are high melting point alloyed metal particles selected from stainless steel particles, Ti—Al—V, or a combination thereof, wherein the high melting point alloyed particles have a D50 particle size from about 1 μm 50 μm.

5. The three-dimensional printing kit of claim 1, wherein the metal shaping particles are low melting point particles selected from copper particles, aluminum particles, Al—Si particles, or Al—Si—Mg particles, or a combination thereof, the low melting point particles having a D50 particle size from about 100 nm to about 20 μm.

6. The three-dimensional printing kit of claim 1, wherein the copper-containing build particles include copper alloy particles comprising from about 50 wt % to about 99 wt % elemental copper.

7. The three-dimensional printing kit of claim 1, wherein the copper-containing build particles include elemental copper particles having a purity from about 99 wt % to 100 wt %.

8. The three-dimensional printing kit of claim 1, wherein the shaping composition is a slurry having a viscosity from about 50 cps to about 5000 cps.

9. A method of controlling green body object deformation comprising:
applying a coating of shaping composition to a surface of a green body object at a surface location to counteract temperature induced deformation of the green body object, wherein the green body object includes copper-containing build particles bound together with build binder, wherein the shaping composition includes metal shaping particles, and wherein the metal shaping particles have a D50 particle size distribution value from about 100 nm to about 100 μm and are also smaller than the copper-containing build particles;
ramping-up temperature applied to the green body object though an intermediate temperature range where the metal shaping particles interact with copper-containing build particles of the green body object, wherein the shaping composition counteracts temperature induced deformation of the green body object while the green body object is within the intermediate temperature range; and
fusing the green body object at a heat-fusing temperature above the intermediate temperature range to form a fused metal object that includes a copper-containing metal body formed from the copper-containing build-particles having a metal coating formed from the metal shaping particles.

10. The method of claim 9, further comprising forming the green body object by:
iteratively applying individual build material layers of a particulate build material including the copper-containing build particles; and
based on a 3D object model, selectively applying a binding agent to individual build material layers to define individually patterned layers that are built up and bound together to form the green body object.

11. The method of claim 9, further comprising removing residual metal shaping particles after fusing leaving the metal coating applied on the copper-containing metal body leaving the metal coating thereon.

12. The method of claim 9, wherein the metal coating has an average thickness from about 100 μm to about 2 mm with an alloyed interface from about 1 μm to about 200 μm in thickness.

13. A three-dimensional printed metal object, comprising:
a copper-containing metal body of heat-fused copper-containing metal particles having a volume density form about 80% to about 99%; and
a metal coating on the copper-containing metal body, the metal coating having an average thickness where present at from about 100 μm to about 2 mm and an alloyed interface from about 1 μm to about 200 μm in thickness, wherein the metal coating has a density difference from about 5% to about 40% by volume relative to the copper-containing metal body.

14. The three-dimensional printed metal object of claim 13, wherein the metal coating is from about 5% to about 25% denser by volume relative to the copper-containing metal body, and wherein the metal coating includes copper, Al—Si—Mg, or a combination thereof.

15. The three-dimensional printed metal object of claim 13, wherein the metal coating is from about 5% to about 25% less dense by volume relative to the copper-containing metal body, and wherein the metal coating includes aluminum, iron, stainless steel, nickel, Ti—Al—V, or combination thereof.
